(19) United States
(12) Patent Application Publication
(10) Pub. No.: US 2013/0323544 A1
(43) Pub. Date: Dec. 5, 2013

(54) Non-Aqueous Electrolyte Secondary Battery

(71) Applicant: Satoshi Kugino, Tokyo (JP)

(72) Inventor: Satoshi Kugino, Tokyo (JP)

(73) Assignee: Shin-Kobe Electric Machinery Co., Ltd., Tokyo (JP)

(21) Appl. No.: 13/985,888

(22) PCT Filed: Feb. 16, 2012
(86) PCT No.: PCT/JP2012/053648

§ 371 Date: Aug. 16, 2013

(30) Foreign Application Priority Data
Feb. 18, 2011 (JP) 2011-033308

(51) Int. Cl. H01M 2/12

(52) U.S. Cl. CPC H01M 2/12
USPC 429/53

(57) ABSTRACT

In non-aqueous electrolyte secondary batteries, an organic solvent is used for an electrolyte. Thus, the non-aqueous electrolyte may be decomposed to produce a gas in the battery to abruptly raise the internal pressure of the battery in an abnormal state such as an internal short circuit or overcharge. In order to prevent a rupture of the battery case due to a rise in internal pressure, the non-aqueous electrolyte secondary battery includes a cleavage valve that opens when the internal pressure rises. The cleavage valve includes a valve element and a ring member, and is installed in a through hole provided in a lid plate. In order to prevent corrosion of the cleavage valve, a corrosion preventing foil is provided to cover the through hole provided in the lid plate of the battery case from inside the battery case to cover the cleavage valve.

### TECHNICAL FIELD

The present invention relates to a non-aqueous electrolyte secondary battery, and to a non-aqueous electrolyte secondary battery in which a contrivance has been made in the structure of a cleavage valve provided at an upper lid of a battery case.

### BACKGROUND ART

In recent years, batteries with reduced size, reduced weight, and increased energy density have been required as drive power sources for various electric apparatuses such as personal computers, particularly along with their tendency toward cordless and portable configurations. In particular, non-aqueous electrolyte secondary batteries such as lithium ion batteries have high energy density, and are expected as leading products that meet such requirements.

For batteries used in a stationary state, in particular, batteries having a rectangular shape with a high volumetric efficiency in the installed state are advantageous from the viewpoint of the energy density per volume compared to batteries having a cylindrical shape discussed according to the related art.

In the non-aqueous electrolyte secondary batteries, an organic solvent is used for an electrolyte. Thus, the non-aqueous electrolyte may be decomposed to produce a gas in the battery to abruptly raise the internal pressure of the battery in an abnormal state such as an internal short circuit or overcharge.

If the gas in the battery is not released, a stress may concentrate on the weakest portion of a battery housing to deform the battery housing to result in a failure. In order to prevent such a failure, a cleavage valve is provided at the battery housing or an upper lid of the battery to release the internal pressure of the battery in the abnormal state. For example, in a secondary battery taught in Patent Document 1, a cutting blade is provided close to a cleavage valve configured to be deformed along with a rise in internal pressure of the battery. When the internal pressure of the battery reaches a predetermined value, the cutting blade breaks the cleavage valve to release the gas in the battery to the outside.

In the secondary battery including the cleavage valve according to the related art, however, the internal space of the battery is in a strong oxidation-reduction atmosphere. Therefore, a thin film portion formed in a valve element of the cleavage valve is occasionally corroded to be broken.

Thus, in a secondary battery taught in Patent Document 2, an organic anti-corrosive agent is applied to the inner side of a valve element to suppress such corrosion.

### RELATED-ART DOCUMENT

### Patent Document

Patent Document 1: JP 11-167909 A

Patent Document 2: JP 3550953

### SUMMARY OF INVENTION

### Technical Problem

In the structure taught in Patent Document 1, the cutting blade is provided in proximity to the cleavage valve. Therefore, the valve may be opened even during normal use if the cutting blade is pushed, which involves the risk of liquid leakage.

In the structure taught in Patent Document 2, an organic anti-corrosive agent is applied to the inner side of the battery. Therefore, the property of the non-aqueous electrolyte and the battery characteristics may be affected if the organic anti-corrosive agent is eluted into the non-aqueous electrolyte.

An object of the present invention is to provide a non-aqueous electrolyte secondary battery that has overcome the issue of corrosion of a cleavage valve without the presence of any component that may affect the battery characteristics in the battery system.

Another object of the present invention is to provide a non-aqueous electrolyte secondary battery including a cleavage valve that can be used without any risk of corrosion during the life period of the battery.

### Solution to Problem

The present invention improves a non-aqueous electrolyte secondary battery including a battery case, an electrode group, and a cleavage valve. The battery case includes a battery case body having an opening portion and a lid plate configured to cover the opening portion. The electrode group is housed in the battery case body, with a separator retaining a non-aqueous electrolyte. The cleavage valve is provided at the lid plate. The valve element may be integrally formed with the lid plate. However, it is not easy to machine the valve element together with the lid plate with high machining accuracy. Therefore, the valve element is separately formed from the lid plate, and fixed to the lid plate. The valve element is small in thickness. Therefore, the valve element is fixed to the lid plate using a ring member to reliably weld the valve element to the lid plate. Thus, in the present invention, the cleavage valve includes a valve element, a ring member, and a corrosion preventing foil. The ring member is configured to fix the valve element to the lid plate. The corrosion preventing foil prevents corrosion of the valve element and the ring member by covering the valve element and the ring member from a back surface side of the lid plate. Use of the thus structured cleavage valve can reliably protect the valve element from corrosion.

In a more specific non-aqueous electrolyte secondary battery according to the present invention, the cleavage valve includes a valve element formed from a material which is corroded by an oxidation-reduction atmosphere in the battery case. A through hole is formed in the lid plate to expose the cleavage valve. The valve element of the cleavage valve is formed of a plate member having a groove formed therein. The ring member is formed from a material which is corroded when the oxidation-reduction atmosphere occurs in the battery case, and fixed to a peripheral portion of a back surface of the valve element to fix the valve element with respect to the through hole air-tightly. The corrosion preventing foil is formed from a material that does not react with the non-aqueous electrolyte and is not corroded by the oxidation-reduction atmosphere. The phrase “material that is not corroded by the oxidation-reduction atmosphere” means a material that is not easily corroded in the oxidation-reduction atmosphere. The corrosion preventing foil is air-tightly fixed to a portion of a back surface of the lid plate located around the through hole to prevent corrosion of the valve element and the ring member by covering the valve element and the ring member without affecting cleaving action of the valve element.

In consideration of the joinability with the valve element, the ring member is preferably formed from the same material as that of the valve element, that is, the material which is corroded when the oxidation-reduction atmosphere occurs in the battery case. Providing the ring member makes it possible to reliably fix the valve element to the through hole air-tightly even if the valve element is small in thickness.

If the lid plate is formed from a metal material, and the valve element and the ring member are formed from a metal material, it is preferable that the valve element and the ring member are fitted in the through hole, and that the ring member is welded to the lid plate. If such a configuration is adopted, welding is performed with the valve element positioned through fitting. Thus, the ring member can be reliably welded to the lid plate, which results in the valve element being firmly fixed to the lid plate.

The metal materials used for the lid plate and the ring member are preferably SUS 304. SUS 304 is readily available and relatively inexpensive. SUS 304 having a thickness required to form a valve element may be corroded to be opened. However, SUS 304 having a thickness required to form a lid plate will not be corroded to permit formation of a hole or the like in the lid plate before the end of the life of the battery is reached. Thus, use of this material can reduce the price of the secondary battery.

The corrosion preventing foil may be an aluminum foil. The aluminum foil has corrosion resistance against an oxidation-reduction atmosphere, and is inexpensive. Therefore, the secondary battery according to the present invention can be manufactured at a low cost.

While the battery case may have any structure, the battery case preferably has a rectangular structure.

### Effect of Invention

The present invention significantly reduces corrosion of a cleavage valve to allow use of the cleavage valve without affecting the pressure at which the cleavage valve is actuated and without reducing the battery characteristics over the extended life period of the battery.

### BRIEF DESCRIPTION OF DRAWINGS

FIG. 1 shows the appearance of a non-aqueous electrolyte secondary battery according to the present invention.

FIG. 2 is a cross-sectional view of a cleavage valve of the non-aqueous electrolyte secondary battery according to the present invention.

### DESCRIPTION OF EMBODIMENTS

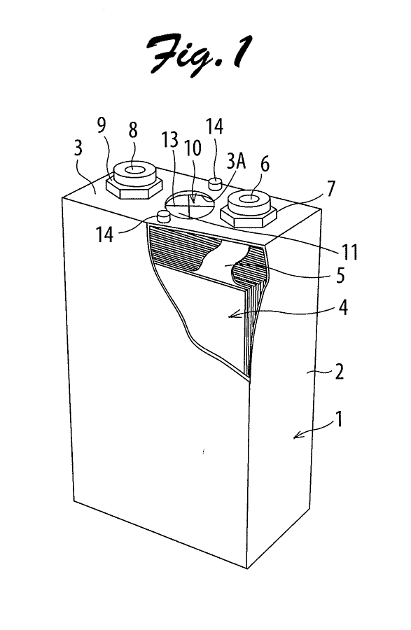

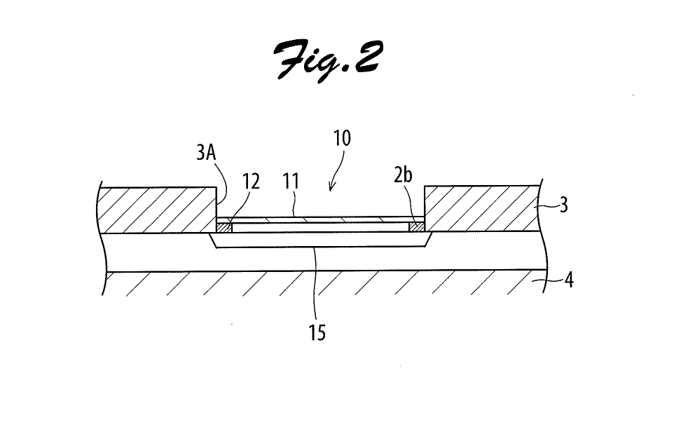

A non-aqueous electrolyte secondary battery according to an embodiment of the present invention will be described in detail below with reference to the drawings. FIG. 1 is a perspective view showing the appearance of a non-aqueous electrolyte secondary battery according to an embodiment of the present invention applied to a stacked lithium-ion battery. FIG. 2 is a schematic cross-sectional view for illustrating the structure of a cleavage valve used in the embodiment. In the embodiment shown in FIG. 1, a battery case 1 includes a battery case body 2 having an opening portion, and a lid plate 3 configured to cover the opening portion. The battery case body 2 and the lid plate 3 are each formed from a SUS 304 stainless plate. A stacked electrode group 4 is received in the battery case body 2. The electrode group 4 includes a plurality of positive electrodes, a plurality of negative electrodes, and separators. Each of the separators is provided between the positive electrode and the negative electrode and retains a non-aqueous electrolyte. A plurality of tabs 5 extend from the plurality of positive electrodes of the electrode group 4, and are connected to a positive current collecting member made of aluminum and fixed to the back surface side of the lid plate 3. The positive current collecting member is integrally provided with a positive terminal portion 6 configured to liquid-tightly penetrate the lid plate 3. The positive terminal portion 6 is fixed to the lid plate 3 via a gasket or a packing (not shown) made of an insulating resin to ensure air tightness. This also ensures insulation between the lid plate 3 and the terminal portion. Threads are formed at the end portion of the positive terminal portion 6. A nut 7 is screwed on the threads to form a positive output terminal. A plurality of tabs extend from the plurality of negative electrodes of the electrode group 4, and are connected to a negative current collecting member made of copper and fixed to the back surface side of the lid plate 3. The negative current collecting member is integrally provided with a negative terminal portion 8 configured to liquid-tightly penetrate the lid plate 3. The negative terminal portion 8 is fixed to the lid plate 3 via a gasket (not shown) or the like as with the positive terminal portion 6. Threads are formed at the end portion of the negative terminal portion 8. A nut 9 is screwed on the threads to form a negative output terminal.

The lid plate 3 is provided with a through hole 3A formed to receive a cleavage valve 10. The cleavage valve 10 includes a valve element 11 made of SUS 304 stainless steel and a ring member made of SUS 304 stainless steel. The ring member 12 is provided to overlap the outer peripheral portion of the back surface of the valve element 11, and welded to the valve element 11 by laser welding. As shown in FIG. 1, the valve element 11 is formed with grooves 13 in an appropriate pattern. The grooves may not necessarily be provided. The ring member 12 is fixed by laser-welding to a portion of the back surface of the lid plate 3 located around the opening portion of the through hole 3A with the cleavage valve 10 fitted in the through hole 3A. The presence of the ring member 12 which is larger in thickness than the valve element 11 allows the cleavage valve 10 to be reliably welded to the lid plate 3. The ring member 12 is formed from a material which is corroded when an oxidation-reduction atmosphere occurs in the battery case 1.

In the embodiment, a corrosion preventing foil 15 made of aluminum is fixed to completely cover both the valve element 11 and the ring member 12 which constitute the cleavage valve 10 from the back surface side of the lid plate 3, and to air-tightly cover the through hole 3A. The corrosion preventing foil 15 has the shape of a circle that is larger in diameter than the through hole 3A. The thickness of the corrosion preventing foil 15 is determined such that the corrosion preventing foil 15 is broken before the internal pressure of the battery case 1 rises to a pressure at which the valve element 11 is opened without affecting cleavage action of the valve element 11. The corrosion preventing foil 15 is welded by the laser to a portion of the back surface of the lid plate 3 located around the opening portion of the through hole 3A. The corrosion preventing foil 15 may be formed from any material that does not react with the non-aqueous electrolyte and is not corroded by the oxidation-reduction atmosphere. The lid plate 3 is provided with a liquid injection port 14 used to inject the electrolyte.

In the embodiment, as described above, it is important that for the lid plate 3 and the cleavage valve 10 including the valve element 11 welded to the lid plate 3 and the ring member 12 configured to hold the valve element 11, the corrosion preventing foil 15 sized to cover the welded portion between the valve element 11 and the ring member 12 is welded by the laser to the back surface of the lid plate 3. This is because adopting such a structure makes it possible to suppress a reduction in opening pressure due to corrosion of the valve element 11 during the life period of the battery. This structure is particularly preferable for application to batteries having a safety valve with a simple structure.

### EXAMPLE

An example of the present invention will be described below with reference to the drawings.

The positive electrodes, the negative electrodes, and the separators forming the electrode group are fabricated as follows. For the positive electrodes, carbon black is dissolved as a conducting agent in a spinel lithium manganese oxide, polyvinylidene fluoride is dissolved as a binding agent in N-methylpyrrolidone, and the two materials are mixed at a predetermined ratio to prepare a mixture. The resulting mixture is applied to both surfaces of an aluminum foil, dried, rolled, and cut into pieces of a predetermined size to prepare positive electrodes. The plurality of positive electrodes in the electrode group are fixed to a positive terminal portion made of aluminum by welding or the like via leads or tabs.

For the negative electrodes, a carbonaceous material is used as the main raw material, polyvinylidene fluoride is dissolved as a binding agent in N-methylpyrrolidone, and the two materials are mixed at a predetermined ratio to prepare a mixture. The resulting mixture is applied to both surfaces of a copper foil, dried, rolled, and cut into pieces of a predetermined size to prepare negative electrodes. The negative electrodes in the electrode group are fixed to a negative terminal portion made of copper by welding or the like via leads or tabs.

The separators are each a microporous film made of polyethylene, and shaped to surround the positive electrodes. Each of the separators is disposed to face the negative electrode.

Then, the positive terminal portion and the negative terminal portion are attached to an electrode group formed by stacking the plurality of positive electrodes, the plurality of negative electrodes, and the plurality of separators. Next, the positive terminal portion and the negative terminal portion are fixed to the lid plate including the cleavage valve and the corrosion preventing foil discussed earlier. Next, the electrode group is inserted into the battery case body, and the lid plate is fixed to the opening portion of the battery case body by laser welding to seal the battery case body. Next, a predetermined amount of the electrolyte is filled into the battery case through the liquid inlet. In the embodiment, the electrolyte is filled into the battery case utilizing a pressure difference generated by disposing the battery in a decompressed desiccator, inserting one end of a hose into the liquid inlet of the battery, and inserting the other end of the hose into a bottle of the electrolyte placed out of the desiccator. The electrolyte has been prepared by dissolving lithium tetrafluoroborate at a concentration of 0.8 M as a solute in a solvent obtained by mixing ethylene carbonate (EC) and dimethyl carbonate (DMC) at a volume ratio of 2:3, and adding an addition agent.

In order to evaluate the corrosion resistance of the lid plate including the cleavage valve fabricated by the method described above, the electrode group in the battery case was disposed in the electrolyte with no positive output terminal and no negative output terminal attached for convenience of the experiment.

Table 1 shows the experimental results. It was confirmed from the table that corrosion of the cleavage valve and consequently liquid leakage were suppressed in the battery in which the foil 15 made of aluminum was welded to cover the cleavage valve 10 including the valve element 11 and the ring member 12 made of stainless steel compared to a battery without a foil 15 made of aluminum. That is, it was confirmed that the structure according to the embodiment is effective means for improving the resistance to liquid leakage and the corrosion resistance.

TABLE 1

| With or without | |
|---|---|
| aluminum foil 15 | Liquid leak (%) |
| With | 0 |
| Without | 3 |

While the present invention is applied to a lithium-ion secondary battery in the embodiment described above, it is a matter of course that the present invention is also applicable to non-aqueous electrolyte batteries other than lithium-ion secondary batteries.

### INDUSTRIAL APPLICABILITY

According to the present invention, it is possible to significantly reduce corrosion of a cleavage valve without the presence of any component that may affect the battery characteristics in the battery. Therefore, the pressure at which the cleavage valve is actuated is not affected and the battery characteristics are not reduced over the extended life period of the battery.

### DESCRIPTION OF REFERENCE NUMERALS

1 battery case
2 battery case body
3 lid plate
3A through hole
4 electrode group
5 tab
10 cleavage valve
11 valve element
12 ring member
13 groove
15 corrosion preventing foil

1.-10. (canceled)

11. A non-aqueous electrolyte secondary battery comprising:
a battery case including a battery case body having an opening portion and a lid plate configured to cover the opening portion;
an electrode group housed in the battery case body, with a separator retaining a non-aqueous electrolyte; and
a cleavage valve provided at the lid plate, and including a valve element formed from a material which is corroded by an oxidation-reduction atmosphere in the battery case,
wherein:
a through hole is formed in the lid plate to expose the cleavage valve; and
the cleavage valve includes:
the valve element formed of a plate member having a groove formed therein;
a ring member formed from a material which is corroded when the oxidation-reduction atmosphere occurs in the battery case, and fixed to a peripheral portion of a back surface of the plate member to fix the valve element with respect to the through hole air-tightly; and
a corrosion preventing foil formed from a material that does not react with the non-aqueous electrolyte and is not corroded by the oxidation-reduction atmosphere, the corrosion preventing foil being air-tightly fixed to a portion of a back surface of the lid plate located around the through hole to prevent corrosion of the valve element and the ring member by covering the valve element and the ring member without affecting cleaving action of the valve element, wherein the corrosion preventing foil is an aluminum foil.

12. The non-aqueous electrolyte secondary battery according to claim 11, wherein:
the lid plate is formed from a metal material; and
the valve element and the ring member are formed from a metal material.

13. The non-aqueous electrolyte secondary battery according to claim 12, wherein
the metal materials are SUS 304.

14. The non-aqueous electrolyte secondary battery according to claim 13, wherein
the valve element and the ring member are fitted in the through hole, and the ring member is welded to the lid plate.

15. A non-aqueous electrolyte secondary battery comprising:
a battery case including a battery case body having an opening portion and a lid plate configured to cover the opening portion;
an electrode group housed in the battery case body, with a separator retaining a non-aqueous electrolyte; and
a cleavage valve provided at the lid plate, wherein
the cleavage valve includes:
a valve element;
a ring member configured to fix the valve element to the lid plate; and
a corrosion preventing foil preventing corrosion of the valve element and the ring member by covering the valve element and the ring member from a back surface side of the lid plate, wherein the corrosion preventing foil is an aluminum foil.

16. The non-aqueous electrolyte secondary battery according to claim 15, wherein
the battery case body and the lid plate are made of a metal or a resin.

17. The non-aqueous electrolyte secondary battery according to claim 16, wherein
the metal is SUS 304.

18. The non-aqueous electrolyte secondary battery according to claim 15, wherein
the battery case has a rectangular structure.
